(19) United States
(12) Patent Application Publication
(10) Pub. No.: US 2022/0260720 A1
(43) Pub. Date: Aug. 18, 2022

(54) DETECTION OF THREE-DIMENSIONAL IMAGE DATA

(71) Applicant: SICK AG, Waldkirch (DE)

(72) Inventors: Markus HAMMES, Waldkirch (DE); Wolfram STREPP, Waldkirch (DE); Jörg SIGMUND, Waldkirch (DE)

(21) Appl. No.: 17/671,380

(22) Filed: Feb. 14, 2022

(30) Foreign Application Priority Data
Feb. 18, 2021 (EP) 21157831.5

(51) Int. Cl. G01S 17/894; G01S 17/32

(52) U.S. Cl. CPC G01S 17/894; G01S 17/32

(57) ABSTRACT

A camera is provided for detecting three-dimensional image data from a detection zone that has an illumination unit for transmitting transmitted light that is modulated at a first modulation frequency, an image sensor having a plurality of reception elements for generating a respective received signal, a plurality of demodulation units for demodulating the received signals at the first modulation frequency to acquire sampling values, a reference illumination unit for transmitting reference light that is modulated at the first modulation frequency and is guided to the image sensor within the camera, and a control and evaluation unit. In this respect, the control and evaluation unit is configured to distribute reference part measurements for a functional test over a plurality of distance measurements.

The invention relates to a camera, in particular to a 3D time of flight camera, and to a method for detecting three-dimensional image data from a detection zone.

Such a camera measures a distance and thereby acquires depth information. The detected three-dimensional image data having spacing values or distance values for the individual pixels are also called a 3D image, a distance image, or a depth map. Different methods are known for determining the depth information. Of these, a time of flight measurement (TOF) or Lidar (light detection and ranging) based on a phase method should be looked at in more detail here.

In this respect, a scene is illuminated by amplitude-modulated light. The light returning from the scene is received and is demodulated at the same frequency that is also used for the modulation of the transmitted light (lock-in process). A measured amplitude value results from the demodulation that corresponds to a sampling value of the received signal. At least two sampling values are required for the phase determination of a periodic signal in accordance with the Nyquist criterion. The measurement is therefore carried out using different relative phasings between the signals for the modulation at the transmission side and the demodulation at the reception side. The absolute phase shift between the transmitted signal and the received signal can thus be determined that is caused by the transit time and that is in turn proportional to the object spacing in the scene.

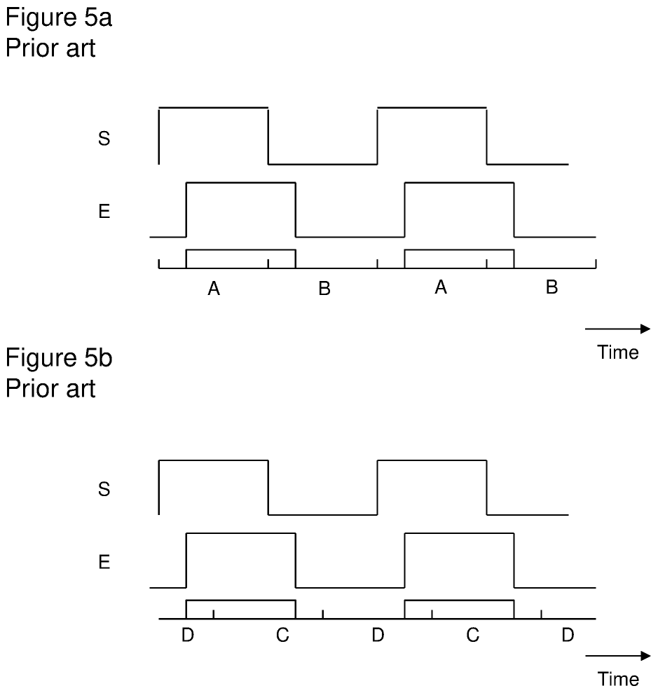

FIG. 5a shows a conventional modulation scheme. The transmitted light that is periodically modulated at the modulation frequency is shown at the top by S The returning received light is designated by E and has a phase offset from the transmitted light S depending on the spacing of the object at which the transmitted light is reflected. Time periods are shown at the bottom that are assigned to charge stores of the respective pixel of the camera in which the photoelectrons generated within the respective time period are stored. The time periods do not, as shown, have to be selected aligned with the transmitted light, but a possible time offset should be taken into account since otherwise a measurement error of the phase and thus of the spacing results.

There are two charge stores A and B at every pixel in FIG. 5a and a switch is made to and from between them at the modulation frequency of the transmitted light. Integration takes place over a plurality of modulation periods, i.e. the accumulating charge carriers are summed and the total charge is only then read out of the pixels, with FIG. 5a showing two such modulation periods. The sought phase is produced from B/(A+B).

A disadvantage of this simple measurement is the sensitivity with respect to extraneous or background light. The minimum number for the phase determination of a periodic signal is admittedly, as stated above, just reached with the two values A and B. However, at least one further sampling value is lacking for the additional taking into account of the further variable of background light that is a constant on the assumption of a constant level. Additional measurements can be carried out to also take background light into account and for further reasons such as the compensation of non-linearities and asymmetries in the pixels of the image sensor that cause relatively high unknown systematic measurement deviations. More than two individual measurements are therefore required for a robust and exact distance measurement to obtain one depth value per pixel or, in other words, it is of advantage if a frame of the 3D image recording comprises more than two part measurements. There is alternatively the option for the determination of the background light to increase the number of charge stores of the pixels, with, however, no compensation of asymmetries in the pixels thus being achieved without repeated individual measurements. Conversely, the pixels can also only have a single charge store and the number of part measurements can be correspondingly increased for compensation.

An expanded modulation scheme for four sampling values is shown together in FIGS. 5a and 5b. The values A and B are determined by the measurement in accordance with FIG. 5a. A further measurement in accordance with FIG. 5b takes place in that the time periods after which a switch is made to and fro between the two charge stores is shifted by ¼ of the period of the modulation frequency. To distinguish the measured values thus acquired, they are marked by C and D. The sought phase is now produced from arctan((C−D)/(A−B)). As already mentioned, the number of charge stores in the pixels can to a certain extent be exchanged for a number of part measurements per frame, with comparable measurements being linked over a constant product of a number of charge stores and a number of part measurements since this product produces the number of the sampling values that are acquired per frame and from which the modulation frequency is reconstructed.

A detailed discussion of the two processes presented with reference to FIGS. 5a and 5b can be found, for example, in the paper by Li, Larry, “Time-of-flight camera—an introduction”, Technical white paper SLOA190B (2014).

In addition to the outlined measurements with two or four sampling values, variants are also known with three sampling values at 0°, 120°, and 240°. In an alternatively image sensor architecture, the measured values of the two charge stores A and B are not individually readable, but are rather differential pixels that output a value A−B. It is furthermore known to measure the sampling values such as A, B, C, and D once more at 180° phase offset to compensate asymmetries in the pixels. The respective number of sampling values brings about different advantages and disadvantages that can be sensible for different applications. The more sampling values that are acquired, the higher the measurement accuracy or the fewer the depth measurement deviations become. The measurement errors become larger with fewer sampling values, but in turn the recording time falls and fewer movement artifacts result.

A further aspect of the time of flight measurement by a phase process is the limited unambiguity range since the phase shift is only unambiguous up to the period of the modulation frequency. To expand the unambiguity range and thus the range of the camera, measurement frequently takes place successively at a plurality of different modulation frequencies. An alternative lowering of the modulation frequency can only be considered within tight limits because the measurement accuracy is thereby impaired. The measurement at a plurality of modulation frequencies combines a high depth resolution with a large depth measurement range. This range increase is possible for any number of part measurements.

The additional distance dimension can be utilized in a number of applications to obtain more information on objects in the scene detected by the camera and thus to satisfy different objects. In automation technology, objects, for example, can be detected and classified with respect to three-dimensional image information in order to make further automatic processing steps dependent on which objects were recognized, preferably including their positions and orientations. The control of robots or different types of actuators at a conveyor belt can thus be assisted, for example.

In vehicles that operate on public roads or in a closed environment, especially in the field of factory and logistics automation, the total environment and in particular a planned travel path should be detected as completely as possible and in three dimensions using a 3D camera. This applies to practically all conceivable vehicles, whether those with operators such as passenger vehicles, trucks, work machines and fork-lift trucks or driverless vehicles such as AGVs (automated guided vehicles), AGCs (automated guided carts). AMRs (autonomous mobile robots) or floor-level conveyors. The image data are used to enable autonomous navigation or to assist an operator to inter alia recognize obstacles, to avoid collisions, or to facilitate the loading and unloading of transport products including cardboard boxes, pallets, containers, or trailers.

In safety engineering, the 3D camera detects persons in the environment of a hazard site, for example of a machine or especially of a robot. On recognition of an unpermitted intrusion into a protected volume or on a falling below of a safety distance from the machine, a safety related response takes place to avoid an accident. Sensors used in safety engineering have to work particularly reliably and must therefore satisfy high safety demands, for example the EN 13849 standard for safety of machinery and the machinery standard IEC61496 or EN61496 for electrosensitive protective equipment (ESPE). To satisfy these safety standards, a series of measures have to be taken such as a safe electronic evaluation by redundant, diverse electronics, functional monitoring, or special monitoring of the contamination of optical components. The safety standards furthermore specify so-called safety levels or safety demand stages by which the achievable safety is classified. Examples for this are SIL in accordance with IE061508/IE061511 (safety integrity level) with 1 as the lowest and 4 as the highest level or PL (performance level) according to EN ISO 13849-1 with a “low” to e “high”.

Applications of safety engineering in the industrial environment have, however, to date still been satisfied by safe light grids or laser scanners. Increasing degrees of automation would per se require more and more complex automation work and geometries that can only be implemented with reservations using these comparatively simple, conventional safety sensors. In fact, however, safe cameras or even 3D cameras are still practically not available on the market or they have substantial restrictions due to range, size, costs, and similar factors. Instead, 3D time of flight cameras are based on a highly integrated image sensor that was developed for completely different applications and in which both the modulation signal for the illumination and the demodulation signals and a large portion of the measurement technology are integrated. These image sensors are consequently not specified with regard to safety applications and the lack of a safety function or the lack of technical safety diagnostic options could also only purely theoretically be complemented by the huge effort of a new chip development that would be simply prohibitive for the volumes of safety engineering.

For a safe design of a conventional safety laser scanner, an internal reference target is provided that samples on every revolution of the laser scanner and for which the expected distance has to be measured. The total measurement chain is thus reliably tested with the same response time at which new scanner data are also delivered. This was first described in DE 43 40 756 A1 and is still customary today. The proven principle can thus not be transferred to a camera due to a lacking scan movement.

It is conceivable in principle to test individual components of the image sensor piece-wise by various stimuli or test patterns. A conclusion on the functional capability of the total measurement chain is then drawn from the functional capability of the individual components. In fact, however, the test patterns have never fully run through the measurement chain. The conclusion on the total measured values is therefore only conceivable at all with a very good understanding of the part regions of the image sensor and is therefore specifically tailored to a specific image sensor. An image sensor change thus causes a huge effort because safety has to be ensured in a fully new manner. The diagnostic degree is nevertheless not sufficient for a high safety level in the sense of the above-named safety standards; at best a middle safety level: can be achieved. One reason for this is that the plurality of tests of part functions by different stimuli require a very large performance time. This is also not only reflected in the effort of these test procedures with respect to processing resources and transit time. If the safety level requires an uncovering of errors within the response time, this is simply too slow.

The still unpublished German patent application having the file reference 102019131988.9 deals with a 3D time of flight camera in which the number of measurement repetitions or part measurements can be adapted. This increases the flexibility and use options, but does not solve the safety problem.

A TOF sensor having a test transmitter is known from EP 3 525 004 B1. The transmitter is interrupted approximately every 100 milliseconds in the operation of the sensor. A test signal is transmitted in the break and the virtual distance measured in this process is compared with an expected value. This test cycle is too long for a high safety level. If the transmitter were interrupted more frequently, this would impair the frame rate and thus the response time since with sufficiently short test cycles a similar amount of time would be needed for the actual measurement as for the test signal.

DE 10 2010 038 566 A1 discloses a further time of flight camera having functional monitoring. A reference channel having a reference light source is provided for this purpose. The reference measurement takes place at predefined time intervals, for example after every distance measurement or at larger time intervals. The disadvantages named in the previous paragraph are again manifested in these alternatives since the frame rate suffers after every distance measurement with a reference measurement, whereas less frequent reference measurements do not achieve a short response time required for a high safety level.

A light scanner on a SPAD (single photon avalanche diode) basis is presented in EP 3 091 271 A1 that has a further light transmitter as a reference light transmitter for a safety related self-test in an embodiment. A pulse process is preferably used here and a cw process is only mentioned without any further explanations. The times at which a self-test could take place without having a negative effect either on the frame rate or on the length of the test cycles is again not clear.

DE 10 2007 008 806 B3 describes an optoelectronic monitoring with a test by dynamization. The received light from the scene is superposed by test light in an external test here. Additional lighting is provided for an internal test that radiates modulated light of a predefined phase into the reception element. There are again no statements on the question of how the required time for this test can be found without either impairing the frame rate or extending the test cycles in a manner incompatible with a high safety level.

It is therefore an object of the invention to improve the safety of a camera of the category.

This object is satisfied by of a camera, in particular by a 3D time of flight camera, and by a method for detecting three-dimensional image data from a detection zone. The camera essentially works as was described in the introduction. An illumination unit generates transmitted light that is modulated at a first modulation frequency. It must be stated as a precaution that this is an artificial amplitude modulation at a selected modulation frequency that should not be confused with the carrier frequency of the actual light wave. The transmitted light reflected back from objects in the detection zone is incident with extraneous light or background light on an image sensor having a plurality of reception elements or pixels that generate a respective received signal therefrom.

A plurality of demodulation units acquire a sampling value in a lock-in process by demodulation using a signal of the first modulation frequency from the respective received signal. For the distance measurement, a first number of at least two part measurements having different phases is carried out between the signals at the modulation frequency for the transmitted light and for the demodulation. Part measurements can be sequential measurement repetitions by a new exposure and/or parallel measurements in a plurality of charge stores of the reception elements. The phasing of the received signal is reconstructed from the plurality of sampling values to obtain the time of flight and finally the distance therefrom. A distance measurement consequently acquires a distance value per involved reception element or pixel and thus forms a frame of the image recording with a plurality of part measurements corresponding to the first number.

A reference illumination unit transmits reference light that is likewise modulated at the first modulation frequency and exposes the image sensor. The reference light is returned to the image sensor internally, unlike the transmitted light, that is within the camera and in particular within a housing of the camera. It accordingly does not exit the camera into the detection zone. A reference channel is formed in this manner in which at least some of the reception elements, preferably all of the reception elements or at least the reception elements corresponding to a safety related region in the detection zone can be actively tested by illumination.

A second plurality of reference measurements are carried out for this functional test analogously to a distance measurement. They are part measurements in which, however, the reference illumination unit now takes over the role of the illumination unit. A reference distance value is determined from the reference part measurements that corresponds without any further modifications to a length of the light path between the reference illumination unit and the image sensor. The reference illumination unit can simulate or emulate different reference distances. An intact camera should at least measure the expected reference distances for a successful functional test.

The distance measurement and the functional test are controlled and evaluated by a control and evaluation unit. In this respect, the demodulation units are preferably already implemented in the pixels that are then also called ToF pixels (time of flight) or lock-in pixels. Further parts of the control and evaluation unit, in particular those that are responsible for the part measurements and the reference part measurements and/or for the reconstruction of the phase from a plurality of sampling values, can already be implemented in the pixels or on the image sensor or integrated on a common chip with the image sensor. An alternative determination of the distance disposed downstream of the image sensor from a plurality of sampling values is also possible, for example in an FPGA (field programmable gate array).

The invention starts from the basic idea of distributing the reference part measurements that are required for a functional test over a plurality of distance measurements or frames. The performance of the second number of reference part measurements thus extends over a plurality of distance measurements or frames. In other words, the reference part measurements are distributed over the part measurements or are interspersed into the part measurements and are carried out less frequently and, again in other words, part measurements are again already carried out for the next distance value or frame without the second number of reference part measurements having been reached within the current frame. It must already be noted here and will be explained in more detail below that functional tests nevertheless remain possible at a high refresh rate up to the frame rate itself by accessing older reference part measurements. The second number of reference part measurements is then nevertheless not reached within a frame.

The invention has the advantage that a reference channel that can be completely integrated in the camera is provided by which the total measurement chain of the three-dimensional image data detection can be tested during the transit time. The already present computing path of the distance calculation can be used for the functional test. This not only simplifies the implementation, but also implicitly simultaneously also tests the distance calculation. The actual recording time of the camera remains largely unimpaired by the distribution of the reference part measurements over a plurality of distance measurements or frames. Functional tests are at the same time only possible within the response time. Depending on the distribution of the part measurements and the reference part measurements, different effects on the power consumption and thus the thermal load of the device result. Overall, the camera can thus be designed as safe in the sense of the safety standards for personal protection, machinery safety or electrosensitive protective equipment named in the introduction or of comparable safety standards and indeed up to a high safety level, for example at least SIL 2 or PL d. A flexible application in a wide field of applications is thus opened up, in particular in mobile applications in which no reliable expectation can be made on parts of the image due to the movement.

The control and evaluation unit is preferably configured to activate only the illumination unit during a part measurement and to activate only the reference illumination unit during a reference part measurement. The two illuminations thus do not interfere with one another; there is exclusively either a part measurement or a reference part measurement. The respective illumination is by no means necessarily active over the total respective time window; on the contrary, there are preferably as many phases as possible wholly without illumination.

The first number and/or the second number preferably amount/s amount to at least three. The respective phase can thus be reconstructed from at least three sampling values of the at least three part measurements or at least three reference part measurements. As discussed in the introduction, two sampling values would generally already be sufficient, but then a constant background light would already distort the distance value up to unrecognizability and at least this offset amount of the background light can be taken into account by a third sampling vale. The phase caused by transit times is generally reconstructed more exactly by additional sampling values and the distance measurement is thus refined. A preferred constellation for three sampling values is achieved by a phase offset between the modulation at the transmission side and the demodulation at the reception side of 0°, 20°, and 240°; with four sampling values, the phase offset preferably amounts to 0°, 90°, 180°, and 270°. More sampling values and different phasings are possible as is an additional part measurement or reference part measurement for an offset or the background light.

The first number is preferably unequal to the second number. This ultimately means different accuracies in the distance measurement and in the functional test. The first number is preferably larger than the second number and the distance measurement is thus more reliable and more precise by more part measurements. Substantially more variability can be expected in the detection zone due to different distances, environmental light, and the like. It is additionally not a question of measurement precision for the anyway fixed distance between the reference illumination unit and the image sensor in the reference channel, but rather solely of revealing errors. Alternatively, the first number is equal to the second number to provide even more similar relationships during a distance measurement and a functional test.

The control and evaluation unit is preferably configured to carry out one reference part measurement or two reference part measurements per distance measurement. There is particularly preferably only exactly one reference part measurement for the first number of part measurements of a distance measurement. The duration of a distance measurement and thus the frame rate are thereby impaired as little as possible. A plurality of reference part measurements are required for the functional test; it is accordingly only possible after a plurality of distance measurements or frames. To accelerate this or, in the case of a preferred access to older reference part measurements still to be described, to remain as current as possible, two reference part measurements per distance measurement can also take place. A determination of the reference distance value from two reference part measurements would anyway be conceivable under the conditions of the functional test that are controlled in comparison with the distance measurement using only internal running paths in the protective housing of the camera. It is, however, not provided in accordance with the invention to determine a reference distance value using the reference part measurements of a single distance measurement and the functional test should preferably, as already stated, be based on at least three reference part measurements for a sufficient reliability.

The control and evaluation unit is preferably configured to carry out at least one reference part measurement in every ith distance measurement. Exactly one reference part measurement or exactly two reference part measurement is/are particularly preferably carried out in every ith distance measurement. i indicates a cycle of the reference part measurements. The case i=1 is preferably permitted so that at least one reference part measurement takes place in every distance measurement. Slower cycles with distance measurements therebetween in which there is no reference part measurement at all result for i>1. Instead of the cycles, irregular distributions are also conceivable, for example one reference part measurement in a first frame, two reference part measurements in a second frame, no reference part measurement in a third frame, and the same, a similar, or a completely different distribution in further frames.

The control and evaluation unit is preferably configured to vary the first number, the second number, the phase offset of the part measurements, the phase offset of the reference part measurements, and/or the distribution of reference part measurements over distance measurements. The camera is therefore not fixed to one configuration, but this can be switched situationally to small time scales or permanently for a longer following operating phase. An adaptation to a different safety level is thus in particular achievable. An example of innumerable conceivable cases is a switch from three part measurements at 0°, 120°, 240° to five part measurements at 45°, 90°, 120°, 270°, and 350°, with this likewise taking place or not in the same or a completely different manner for the reference part measurements. Another example is a switch from a respective one reference time measurement per distance measurement to now two reference part measurements in every third distance measurement. The response time and accuracy of the distance measurement, the reliability of the functional test, the cycle times, and ultimately also a safety level can thus be adapted. Such a change can in particular diversify the functional test.

The control and evaluation unit is preferably configured to determine a reference distance value from at least one current reference part measurement, a current distance measurement, and at least one earlier reference part measurement of an earlier distance measurement, in particular to determine a reference distance value with each distance measurement in this manner. This is the access to older reference part measurements already indicated multiple times by a kind of rolling process similar to a rolling mean. Since the second plurality of reference part measurements is not reached within a single distance measurement, older reference part measurements with the currently not measured phase references are added. The older or earlier reference part measurements are preferably the latest available ones. The functional test can thus be carried out more frequently because it is not necessary to wait for a completion of the second plurality. One functional test per distance measurement or frame is in particular even possible even though the involved reference part measurements were collected over a plurality of frames.

The control and evaluation unit is preferably configured to use a shorter integration time during the reference part measurements than during the part measurements. The integration time or exposure time designates the time window in which the reception elements collect photons for a corresponding sampling value. Due to the well-defined relationships in the reference channel, including the short and known light path, it is sufficient to integrate over a comparatively shorter time period. The measurement time taken up by the reference part measurements is thereby further reduced that was anyway already limited by the distribution over a plurality of distance measurements. In the measurement channel for possibly far and dark objects, in contrast, this shorter integration time would not be sufficient.

The control and evaluation unit is preferably configured to check at least one function of the image sensor using only one reference part measurement, in particular to localize defective pixels. The actual functional test for the total measurement chain with determination of a time of flight is only possible with a plurality of reference part measurements. Complementary functional tests can, however, also already take place on the basis of only a single reference part measurement to uncover errors of the image sensor. Defective pixels, pixel groups, or defects in the rows or columns or their reading and control are thereby revealed, for example.

The control and evaluation unit is preferably configured to carry out further part measurements and/or reference part measurements at at least one second modulation frequency. The unambiguity range is expanded, as explained in the introduction, by measuring at two or more modulation frequencies. A respective plurality of part measurements are required for every modulation frequency, with the number of measurement repetitions in turn preferably, but not necessarily, being the same per modulation frequency. It is conceivable to adapt the number of the modulation frequency and the modulation frequencies in dependence on the required range and measurement resolution. The unambiguity range does not play any role in the reference channel with its freely settable transit times. A test is nevertheless preferably also made there for an even more reliable diagnosis at a plurality of modulation frequencies, i.e. reference part measurements are preferably carried out at the first modulation frequency and/or at least the second modulation frequency. Even more combination options are now produced such as reference part measurements that can be interspersed into distance measurements since the modulation frequencies provide further degrees of freedom here. It is admittedly advantageous in this respect, but by no means necessary, if the same modulation frequency is respectively used in the reference channel as currently in the measurement channel. The reference light source can be controlled separately at its own modulation frequency, even a modulation frequency that is never used in the measurement channel.

The control and evaluation unit is preferably configured to impart an artificial delay on the reference light. A reference target is thereby emulated or simulated at a different distance than corresponds to the physical light path. The delay can be negative; the reference target then appears to move closer. Artificial delays expand and diversify the functional test again.

The reception elements preferably have a plurality of charge stores. As already explained in the introduction, a plurality of sampling values can be simultaneously acquired by a plurality of charge stores; the charge stores accordingly enable a plurality of simultaneous part measurements or reference part measurements However, with too many charge stores, only a small proportion of the integration time falls on the individual charge store so that this division of the finite number of incident photons has its limits. Exactly two charge stores per reception element are particularly advantageous and even more preferably the two charge stores are read differentially. They then do not deliver one sampling value A for the one charge store and a second sampling value B for the other charge store, but the difference of A−B. There are also repeat part measurements with different phase references within one distance measurement with a plurality of charge stores. This, on the one hand, serves to obtain further sampling values in different phases. An offset by 180° is also advantageous, and indeed both with differential and with individual reading. For the same phases are thereby admittedly measured in theory, but in practice there are asymmetries in the channels formed by the charge stores that can be compensated by a double mutually inverse measurement at 180°. Alternatively, embodiments having only one charge store per reception element are possible.

The reference light is preferably guided directly to the image sensor via at least one reflective zone and/or a light guide. This allows design freedom for the interior of the camera. The reflective one can be combined with or integrated in a different element, for example an optics, a front screen, a shield, a housing part, or the like and practically any desired light paths or parts thereof that adapt to the circumstances in the camera can be implemented with a light guide.

The control and evaluation unit is preferably configured to vary a frame rate at which distance measurements are repeated. The frame rate cannot be faster than specified by the respective selected first number of part measurements and by the range. However, a change of the range and thus a shortening of part measurements and a slowing of the frame rate or a removal of a slowing is possible. The light transmission is reduced and energy saved by waiting times with a frame rate below the technically possible one.

The control and evaluation unit is preferably configured to adapt the transmitted light of the illumination unit. There are a large number of conceivable criteria for this; for instance, the required range of the measurement, certain regions of interest within the detection zone, or the extraneous light load. The adaptation can take place by switching illumination modules of the illumination unit on and off or alternatively by means of an adaptive illumination unit that is designed such that the transmitted light can be distributed in the scene spatially and/or temporally selectively. An adaptation of the reference light is likewise conceivable, but since the relationships in the interior of the camera do not change, a one-time, fixed setting is sufficient as a rule here. It is anyway conceivable to dispense with the functional test of reception elements at least temporarily for reception elements that are at least instantaneously not safety relevant; for example, are outside a region of interest where the detection zone is anyway not sufficiently illuminated due to an adaptation of the illumination unit.

The method in accordance with the invention can be further developed in a similar manner and shows similar advantages in so doing. Such advantageous features are described in an exemplary, but not exclusive manner in the subordinate claims dependent on the independent claims.

The invention will be explained in more detail in the following also with respect to further features and advantages by way of example with reference to embodiments and to the enclosed drawing. The Figures of the drawing show in:

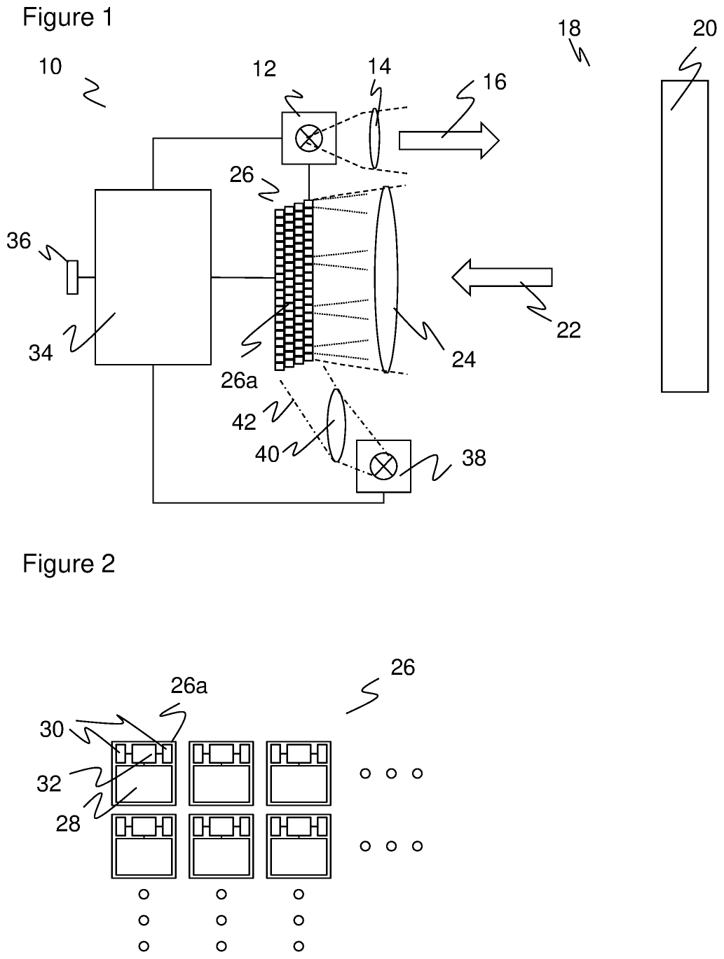

FIG. 1 a schematic block illustration of a 3D time of flight camera sensor with a directly illuminating reference channel;

FIG. 2 a plan view of reception pixels of a 3D time of flight camera with two charge stores;

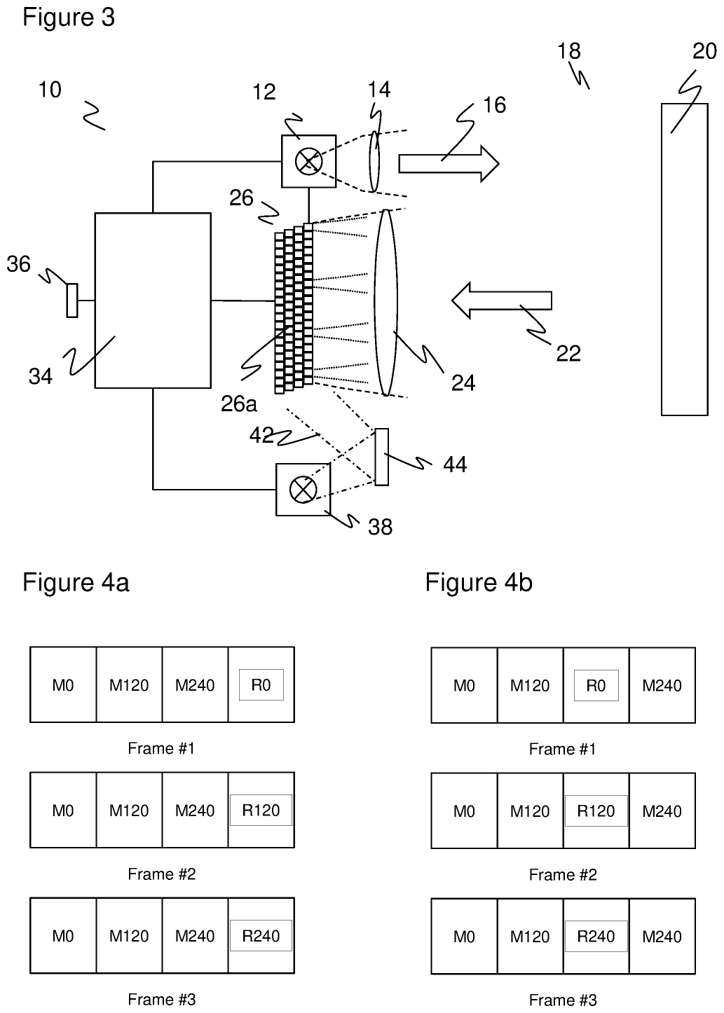

FIG. 3 a schematic block illustration of a 3D time of flight camera with a reflective reference channel;

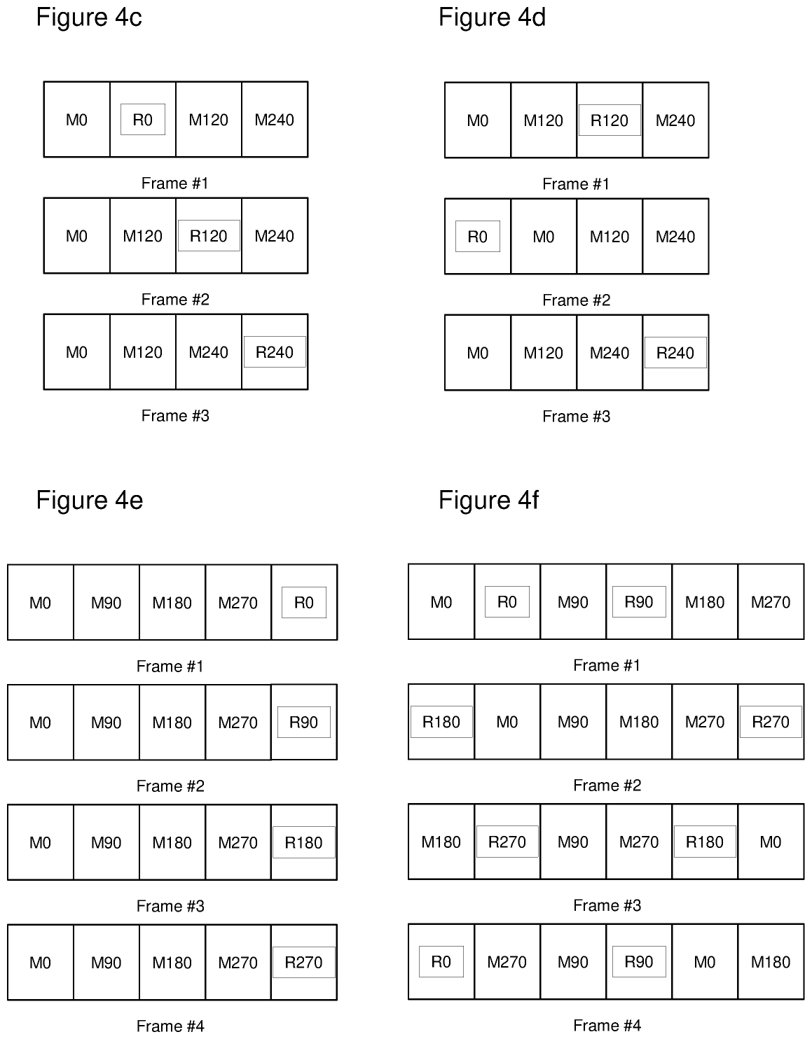

FIG. 4a an exemplary distribution of a respective reference light measurement at the end of a distance measurement;

FIG. 4b an exemplary distribution of a respective reference light measurement between part measurements of a distance measurement;

FIG. 4c an exemplary cyclically changing distribution of a respective reference light measurement between different part measurements of a distance measurement;

FIG. 4d an exemplary irregular distribution of a respective reference light measurement between different part measurements of a distance measurement;

FIG. 4e an exemplary distribution of a respective reference light measurements at the end of a distance measurement similar to FIG. 4a, but now with four instead of three part measurements of a distance measurement;

FIG. 4f an exemplary irregular distribution of two respective reference light measurements between different part measurements of a distance measurement;

FIG. 5a a representation of a conventional modulation scheme with two sampling values for the distance measurement; and

FIG. 5b a representation of a conventional expanded modulation scheme with four sampling values.

FIG. 1 shows a schematic block illustration of a camera 10 that is preferably configured as a 3D time of flight camera. An illumination unit 12 transmits transmitted light 16 modulated by a transmission optics 14 into a detection zone 18. LEDs or lasers in the form of edge emitters or VCSELs can be considered as the light source. The illumination unit 12 is controllable such that the amplitude of the transmitted limit 16 is modulated at a frequency typically in the range of 1 MHz to 1000 MHz The modulation is, for example, sinusoidal or rectangular, at least a periodic modulation. To reduce the mutual influencing of a plurality of systems, an artificial jitter or a kind of coding (spread spectrum) can also be used. A limited unambiguity range of the distance measurement is produced by the frequency so that smaller modulation frequencies are required for large ranges of the camera 10. Alternatively, measurements are carried out at two to three or more modulation frequencies to increase the unambiguity range in a combination of measurements.

When the transmitted light 16 is incident on an object 20 in the detection zone 18, a portion of the received light 22 is reflected back to the camera 10 and is guided there through a reception optics 24, for example a single lens or a reception objective, onto an image sensor 26. The image sensor 26 has a plurality of reception elements or reception pixels 26a arranged to form a matrix or a row, for example. The resolution of the image sensor 26 can reach from two or some few up to thousands or millions of reception pixels 26a.

FIG. 2 shows a plan view of a detail of the reception pixels 26a of the image sensor 26. This view is purely functional and schematic; the specific semiconductor design of the image sensor 26 is not the subject of this description. The reception pixels 26a each have a light sensitive surface 28 and at least one charge store 30, for example a capacitor. In the embodiment in accordance with FIG. 2, there are two charge stores 30 by way of example. Further switch elements of the reception pixels 26a are combined very schematically and purely symbolically in a block as a demodulation unit 32. The reception pixels 26 detect the received light 22 in their charge stores 30 during a measurement period or an integration time. In this respect, the demodulation unit 32 controls when charges are collected in the charge store 30 in accordance with the modulation frequency also used for the modulation of the transmitted light 16. A demodulation corresponding to a lock-in process consequently takes place.

The pixel arrangement is typically a matrix so that a lateral spatial resolution results in an X direction and in a Y direction, which is supplemented by the Z direction of the distance measurement to form the three-dimensional image data. This 3D detection is preferably meant when a 3D camera, a 3D time of flight camera, or three-dimensional image data are spoken of. In principle, however, different pixel arrangements are also conceivable; for instance, a pixel row that is selected in a matrix or that forms the whole image sensor of a line scan camera.

Referring back to FIG. 1, the charge quantities collected in the charge stores 30 of the reception pixels 26a are read, digitized, and transferred to a control and evaluation unit 34. Two sampling values are produced by the two charge stores 30. Alternatively to a single reading of both sampling values, differential reception pixels 26a are also conceivable that output a difference of the two charge stores 30 as a single sampling value. The information relevant to the phase determination is here practically of equal value since differences are anyway formed in the evaluation. To acquire additional sampling values, the described part measurement with the collection and reading of charge stores 30 is repeated n times, preferably two to four times. In this respect, the phase between the modulation frequency used for the transmitted light 16 and the modulation frequency used for demodulation in the demodulation unit 32 is respectively varied between the part measurements.

The control and evaluation unit 34 now reconstructs the phase offset from the plurality of sampling values on the basis of the time of flight through the detection zone 18 that can be converted into a distance value per reception pixel 26a. A three-dimensional image, distance image, or depth image, that is output at an interface 36, is produced. The interface 36 or, alternatively, one or more further connectors, not shown, conversely serve for the input of control signals or parameterizations of the camera 10.

The distance measurement thus takes place in accordance with an indirect time of flight process whose principle was already described in the introduction. For example, for the determination of a distance value, three part measurements take place successively with a respective phase reference of 0°, 120°, and 240° or four part measurements take place successively with a respective phase reference of 0°, 90°, 180°, and 270°, with the calculations of the distance for the latter embodiment having been specified in the introduction with reference to FIGS. 5a-b.

There are a large number of variants for this that differ in a number of part measurements and the respective phase reference between the transmitter modulation and the receiver modulation within the part measurements. To provide an arbitrary and practically not particularly relevant example, seven part measurements at 6°, 90°, 105°, 170°, 250°, 300°, and 310° would also be possible. Furthermore, alternatively to the embodiment shown in FIG. 2 with two charge stores 30, more charge stores or only one single charge store are conceivable. The number of charge stores 30 enables the simultaneous acquisition of a plurality of sampling values so that part measurements carried out simultaneously and successively can be exchanged with one another in a certain manner.

The shown embodiment with two charge stores 30 that sample phase offset from one another by 180° and that are then even more preferably differentially read is preferred. It is advantages both with and without a differential reading to carry out a respective additional part measurement at an offset of 180° from another part measurement. With three part measurements, a measurement is then preferably made in the phase reference 0°, 180°; 120°, 300°; 240°, 60°, and with four part measurements in the phase reference 0°, 180°; 90°, 270°; 180°, 0°; 270°, 90°. Particularly the latter appears redundant, but serves to compensate hardware-induced differences in the two channels formed by the charge stores 30. A total of eight individual sampling values A, B, C, D, A′, B′, C′, D′ or with differential pixels four differences of sampling values A−B, C−D, A′−B′, C′−D′ are then present. The sought phase is then produced as arctan(((C−D)−(C′−D′))/((A−B)−(A′−B′))). With different numbers of part measurements or a different mutual offset, a different formula is naturally produced, but the reconstruction of the phase remains possible with known mathematical means that can be implemented with small resources.

A diagnostic or reference illumination unit 38 is provided in addition to the illumination unit 12 for a functional test of the camera 10 and generates reference light 42 via an optional reference optics 40 by which the image sensor 26 is internally illuminated. Internally means that the light path of the reference light 42 runs within the camera 10, in particular within its housing, not shown, and thus does not enter into the scene of the detection hone 18 and is thus not influenced by the scene and its environmental conditions. In the embodiment in accordance with FIG. 1, the reference light 42 is coupled onto the image sensor 26 directly by a reference illumination unit 38 that can preferably be arranged close to the image sensor 26 and, alternatively to the representation, while avoiding shading between the image sensor 26 and the reception optics 24. Alternative embodiments of the reference channel will be presented below with reference to FIG. 3.

The above statements on the illumination unit 12 apply accordingly to the structure and to the light source of the reference illumination unit 38, with smaller demands being made on the reference illumination unit 38 due to the short internal light path. A compact and inexpensive laser diode or LED can therefore be used since only a small light power is anyway needed and a powerful light source would even have to be restricted to avoid saturation. The reference illumination unit 38 can be controlled separately from the image sensor 26 by a modulation signal. For this purpose, for example, a second control channel of the image sensor 26 can be used, if present, or alternatively, a selection is made via corresponding enable signals whether the illumination unit 12 or the reference illumination unit 39 is acted on by the modulation signal.

A reference channel for the functional test is thus produced in addition to the actual measurement channel. The reception pixels 26a measure reference distance values via the reference channel analogously to the distance values of the measurement channel. In an intact system, the reference distance values have to correspond to an expectation, namely the internal light paths from the reference illumination unit 38 to the image sensor 26. Dynamic changes of the scene of the detection zone 18 have no effect on these internal light paths. It Is conceivable to emulate different distances for the reference distance value to be measured by additional artificial delays between the modulation and the demodulation. A possible phase-dependent measurement error of the diagnosis thus in particular becomes accessible. The respective expectation for an intact system is initially taught or is specified due to theoretical considerations or simulations.

The control and evaluation unit 34 thus recognizes when the camera 10 can no longer reliably satisfy its object using the reference channel. In a technical safety application, a safety relevant signal is preferably output in an error case via which a machine, a vehicle, a robot, or another monitored hazard side is moved to a safe state, either by slowing, evading, or stopping.

The division of FIGS. 1 and 2 into an image sensor 26 having reception pixels 26a that each have a demodulation unit 32 and into a control and evaluation unit 34 is only a preferred embodiment. The control and evaluation function can also be differently distributed. The control and evaluation unit 34 also by all means does not have to consist monolithically of a single module, as shown, but can rather be composed of one or more digital computing modules such as microprocessors, FPGAs (field programmable gate arrays) or ASICS (application specific integrated circuits). The illumination shown is furthermore an area illumination, for which purpose, for example, a diffuser is used as part of the transmission optics 14. In another embodiment, an arrangement of a large number of individual light sources of the illumination unit 12 is projected as sharp into the detection zone 18 so that as a result the reception pixels 26a are exposed individually and the range increases. Deviating from the illustration, the illumination can furthermore not be integrated in the camera 10, but can rather be separated from it in construction or in space.

FIG. 3 shows a further embodiment of the camera 10. Only the reference channel has been changed with reference to FIG. 1. The light path of the reference light 42 from the reference illumination 38 to the image sensor 26 is not direct here, but rather folded once with the aid of a reflection element 44. An optional reference optics 40 would likewise be possible. The reflection element 44 can be a separate element or an at least partly reflective region of a different element is used or attached there, for instance to one of the optics 14, 24, a front screen, a shield of a transceiver chip, or a housing component. The light path of the reference light 42 can also be folded or deflected multiple times. As a further alternative, at least sections of this light path are conceivable in a light guide, with reflections and light guides being able to be combined with one another. It is ultimately only important that sufficient reference light 44 reaches an internal, reproducible light path on the image sensor 26 and illuminates the reception pixels 26a to be tested there.

FIGS. 4a-f show different exemplary schemes how reference part measurements for the functional test can be interspersed in the part measurements of the distance measurements. The functional test or the reference measurement is thereby distributed over a plurality of distance measurements or frames of the camera 10. The required additional time and power loss for the functional test are thus spread over a longer time interval.

FIG. 4a shows a first embodiment in which aa distance measurement is based on three part measurements with a phase reference between the modulation and demodulation of 0°, 120°, and 240° and equally on three reference measurements on the determination of a reference distance value for the functional test. The reference part measurements are each inserted at the end of a distance measurement or of a frame (image recording period) in this embodiment, and indeed only one reference time measurement per frame. The inserted reference part measurement has its own phase reference independently of the part measurements that changes from frame to frame. In the first frame, a reference part measurement takes place with a phase reference of 120°, and in the third frame with a phase reference of 240°. The respective intermediate results are stored, for example, in a pre-processing, preferably an FPGA, or anywhere else in a storage area accessible to the control and evaluation unit 34. After the third frame, a complete reference channel data set is present from which a reference distance value is produced. The cycle shown is then repeated.

FIG. 4b shows a further embodiment in which the reference part measurements are now no longer inserted at the end of a frame, but rather between the second and third part measurements. They could equally be inserted between the first and second part measurements or could be placed at the start of a frame. The time at the start of a frame is inter alia not equivalent to the time at the end of the preceding frame due to the computing times between two frames.

FIG. 4c shows a further embodiment in which the reference part measurements are inserted cyclically alternatingly between different part measurements of a frame. This cycle could start alternatively at another time between different part measurements , can run in the opposite direction, and similar.

FIG. 4d shows a further embodiment that is intended to illustrate that even with a fixed number of part measurements per frame, of reference part measurements per frame and per functional test and fixed phase relationships, there are very many more further schemes to distribute the reference part measurements within the frames and over the frames. In the embodiment shown, the time of the reference part measurement within a frame changes in an irregular manner that thus repeats after the third frame or continues to change irregularly. The sequence of the phase references of the reference part measurements is moreover changed; measurement is now first made at 120°, then at 0°, and then at 240°. This can also repeat after the third frame or change its order. The sequence of the phase references of the part measurements within a frame could likewise change from frame to frame.

FIG. 4e shows a further embodiment that in principle corresponds to that of FIG. 4a in which exactly one reference part measurement is respectively carried out at the end of every frame. However, the number of part measurements per frame has increased to four and the phase references are now accordingly 0°, 90°, 180°, and 270°. The same applies accordingly to the reference part measurements that are now carried out at a phase reference of 0° in the first frame, at a phase reference of 90° in the second frame, at a phase reference of 180° in the third frame, and at a phase reference of 270° in the fourth frame. It is understood that further embodiments analogously to FIGS. 4b-d are possible in which the reference part measurements vary their times within the frames and the sequence of the phase references of the part measurements and/or reference part measurements. Different numbers of part measurements and reference part measurements as well as five and more and different phase references are equally possible.

FIG. 4f shows a further embodiment in which now two reference part measurements per frame are carried out. The example shown uses irregular times of the reference part measurements within the frames and a non-increasing sequence of phase references, with the specific representation only being representative of the possible irregularities. Repeating similar cycles or times that are regular overall, for instance at the start, in the middle, or at the end of a frame and/or an increasing sequence of the phase references are equally conceivable. A further variant, not shown, varies the number of reference part measurements that are respectively inserted into a frame, for example one reference part measurement in the first frame, two reference part measurements in the second frame, no reference part measurement in the third frame, and one reference part measurement in the fourth frame, which then repeats cyclically or continues irregularly. Longer cycles are further conceivable in which reference part measurements are respectively only inserted in every second, third, or generally ith frame.

The embodiments shown in FIGS. 4a-f are non-exclusive examples that are combined with one another and even then only represent some of innumerable options. The number of part measurements of a distance measurement and/or the number of reference part measurements that underly a functional test can furthermore be varied as can the associated phase references. This is even differently possible for the distance measurement and the functional test, for example a distance measurement with four part measurements at 0°, 90°, 180°, and 270° and a functional test of three reference part measurements at 0°, 120°, and 240°. Differential pixels can be used. The order in which the phase references can follow one another in the part measurements or in the reference part measurements can be mixed up cyclically and non-cyclically. The reference measurements can be inserted at different times of a respective frame, and indeed the same or different from frame to frame.

A variation option not represented in FIGS. 4a-f relates to the modulation frequencies used. In principle, measurement channels and the reference channel are independent of one another in this relationship. It is therefore conceivable that distance values are measured at a first modulation frequency and the reference part measurements use a completely different modulation frequency. Or distance values having a larger unambiguity range are measured at a first modulation frequency and at a second modulation frequency, while the reference part measurements use, depending on the embodiment, this first modulation frequency and second modulation frequency, only one thereof, a different modulation frequency, or even two and more different modulation frequencies. At least one further degree of freedom of the modulation frequency thereby results that can be combined with all the previously described variation options.

A functional test is thus based on reference part measurements from different frames. However, this by no means means that a functional test is only possible every n>1 frames if a respective new set of reference part measurements has been completed. This is admittedly possible, but produces a very sluggish response time of the functional test that is not necessarily sufficient for high safety levels.

To be able to carry out the functional test within fewer frames and preferably with each frame, a rolling process is preferably used analogously to a rolling mean. In this respect, the determination of a reference distance value is based on a reference part measurement from a current frame and stored reference part measurements on the other still required phase relationships from earlier frames, preferably the directly preceding frames. The expectation on the reference distance value is preferably kept so tight that a deviation that can already not be tolerated from a safety aspect or an error is only recognized in the current reference part measurement.

This rolling process will be briefly substantiated for the example of FIG. 4a; it can be used analogously for all other variants. In the first frame, a reference part measurement takes place with a phase reference of 0°; a reference distance value cannot yet be acquired therefrom. In the second frame, a reference part measurement takes place with a phase reference of 120° and the two reference part measurements now present are still not sufficient for the determination of a reference distance value. In the third frame, a reference part measurement takes place with a phase reference of 240° and the system has now settled for the first time within small fractions of a second; a reference distance value can be determined from the three present reference part measurements at 0°, 120°, 240°, even through only the reference part measurement at 240° originates from the current frame. In the fourth frame, a reference part measurement again takes place with a phase reference of 0° with which the older reference part measurement with a phase reference of 0° from the first frame is replaced for the determination of a reference distance value.

It can thus be achieved that both the response time of the actual measurement and of the functional test remain short. The determination of a distance value is practically not noticeably delayed by the distribution of the reference part measurements over a plurality of frames. At the same time, functional tests are possible with a short response time up to once per frame by the described rolling process. In accordance with the invention, high safety levels such as SIL 2 or PL d can thus also be reached.

The total integration time for all the part measurements typically takes up approximately ⅓ of the cycle time of the camera 10. The raw data are subsequently offset and the actual 3D image is calculated that is then evaluated for the application. Said cycle time thus corresponds to the possible frame rate that can, however, still be artificially slowed to, for example, correspond to an external expectation on the interfaces of the camera 10 or on a configuration.

The integration time for the reference time measurements can be very small in comparison with the integration time for a part measurement. The signal intensity of the reference illumination unit 38 is well known and is reproducible and not damped due to the independence from the scene in the detection zone 18. A brief integration time not only shortens the duration that is as short as possible and that a reference part measurement takes in a frame since the response time of the camera 10 should not be impaired by the functional test at all or at least only a little. It additionally reduces a power loss in the image sensor 26 with an only brief application of the demodulation signals since the modulation and demodulation running during the integration time are responsible for a large part of the power loss in the image sensor 26 and even in the total camera 10. The time gained by a brief integration time can alternatively be used for a still higher degree of diagnosis that tests additional phase relationships, frequency changes, and the like. However, this is then accompanied by a comparatively higher power loss.

In addition to the described functional test of the entire measurement chain using a plurality of reference part measurements, the respective current reference part measurement can still be evaluated per se and without a time of flight evaluation for errors occurring locally in the image such as defective pixels, columns, or rows. Such local errors can already be recognized without the offsetting of a plurality of reference part measurements to one reference distance value.

Alternatively to the distribution of reference part measurements over a plurality of frames, a complete reference channel data set having all the reference part measurements required for this purpose could be recorded within a single frame and this then takes place with every frame or every n frames. However, this only works when the image sensor 26 and the raw data processing taking place downstream are fast enough; this otherwise results in extended response times of the actual measurement or in a reduced frame rate. This problem is solved by the distribution of reference part measurements between the part measurements of different frames.

1. A camera for detecting three-dimensional image data from a detection zone, the camera comprising
an illumination unit for transmitting transmitted light that is modulated by at least one first modulation frequency;
an image sensor having a plurality of reception elements for generating a respective received signal;
a plurality of demodulation units for demodulating the received signals at the first modulation frequency to acquire sampling values;
a reference illumination unit for transmitting reference light that is modulated by the first modulation frequency and is guided to the image sensor within the camera;
and a control and evaluation unit that is configured, for a distance measurement, to control the illumination unit and/or the demodulation unit for a first number of part measurements with a respectively different phase offset between the first modulation frequency for the transmitted light and the first modulation frequency for the demodulation and to determine a distance value from the sampling values acquired by the part measurements per reception element;
and, for a functional test, to control the reference illumination unit and/or the demodulation units for a second number of reference part measurements with a respectively different phase offset between the first modulation frequency for the reference light and the first modulation frequency for the demodulation and to determine a reference distance value from the sampling values acquired by the reference part measurements per reception element,
wherein the control and evaluation unit is further configured to distribute the reference part measurements for a functional test over a plurality of distance measurements.

2. The camera in accordance with claim 1,
wherein the camera is a 3D time of flight camera.

3. The camera in accordance with claim 1,
wherein the control and evaluation unit is configured to activate only the illumination unit during a part measurement and to activate only the reference illumination unit during a reference part measurement.

4. The camera in accordance with claim 1,
wherein at least one of the first number and the second number amounts to at least three.

5. The camera in accordance with claim 1,
wherein the first number is not the same as the second number.

6. The camera in accordance with claim 1,
wherein the control and evaluation unit is configured to carry out one reference part measurement or two reference part measurements per distance measurement and/or to carry out at least one reference part measurement in every ith distance measurement.

7. The camera in accordance with claim 1,
wherein the control and evaluation unit is configured to vary at least one of the first number, the second number, the phase offset of the part measurements, the phase offset of the reference part measurements, and the distribution of reference part measurements over distance measurements.

8. The camera in accordance with claim 1,
wherein the control and evaluation unit is configured to determine a reference distance value from at least one current reference part measurement, a current distance measurement, and at least one earlier reference part measurement.

9. The camera in accordance with claim 8,
wherein the control and evaluation unit is configured to determine a reference distance value with each distance measurement in this manner.

10. The camera in accordance with claim 1,
wherein the control and evaluation unit is configured to use a shorter integration time during the reference part measurements than during the part measurements.

11. The camera in accordance with claim 1,
wherein the control and evaluation unit is configured to check at least one function of the image sensor using only a reference part measurement.

12. The camera in accordance with claim 11,
wherein the control and evaluation unit is configured to check the at least one function of the image sensor using only a reference part measurement to localize defective pixels.

13. The camera in accordance with claim 1,
wherein the control and evaluation unit is configured to carry out further part measurements and/or reference part measurements at at least one second modulation frequency.

14. The camera in accordance with claim 1,
wherein the control and evaluation unit is configured to impart an artificial delay on the reference light.

15. The camera in accordance with claim 1,
wherein the reception elements have a plurality of charge stores.

16. The camera in accordance with claim 1,
wherein the reception elements have two charge stores that are read differentially.

17. The camera in accordance with claim 1,
wherein the reference light is guided directly to the image sensor via at least one reflective zone and/or a light guide.

18. The camera in accordance with claim 1,
wherein the control and evaluation unit is configured to vary a frame rate at which distance measurements are repeated.

19. The camera in accordance with claim 1,
wherein the control and evaluation unit is configured to to adapt the transmitted light of the illumination unit.

20. A method of detecting three-dimensional image data from a detection zone,
in which transmitted light is transmitted that is modulated at at least one first modulation frequency;
received light is received from the detection zone and, spatially resolved therefrom, a plurality of received signals are generated;
the received signals are demodulated at the first modulation frequency to acquire sampling values;
for a distance measurement, a first number of part measurements is carried out with a respective different phase offset between the first modulation frequency for the transmitted light and the first modulation frequency for the demodulation and a respective distance value is determined in a spatially resolved manner from the sampling values acquired by the part measurements;
reference light is transmitted that is modulated by the first modulation frequency and is received again without a light path through the detection zone;
and, for a functional test, a second number of reference part measurements is carried out with a respectively different phase offset between the first modulation frequency for the reference light and the first modulation frequency for the demodulation and a respective reference distance value is determined from the sampling values acquired in a spatially resolved manner by the reference part measurements,
characterized in that
wherein the reference part measurements for a functional test are distributed over a plurality of distance measurements.
